(19) United States
(12) Patent Application Publication
(10) Pub. No.: US 2025/0043378 A1
(43) Pub. Date: Feb. 6, 2025

(54) HIGH-STRENGTH STEEL WITH EXCELLENT NEUTRAL AQUEOUS MEDIUM CORROSION RESISTANCE AS WELL AS PREPARATION METHOD AND APPLICATION THEREOF

(71) Applicants: WUHAN UNIVERSITY OF SCIENCE AND TECHNOLOGY, Wuhan (CN); WUKE XINCAI (WUHAN) TECHNOLOGY CO., LTD., Wuhan (CN); WUKE COMPOSITE MATERIALS (HAIKOU) TECHNOLOGY CO., LTD., Haikou (CN); SINO-ENERGY HUAYUAN FLOATING WIND INSTITUTE, Qingdao (CN)

(72) Inventors: Kaiming WU, Wuhan (CN); Shi CHENG, Wuhan (CN); Shaoguan XIANG, Wuhan (CN)

(73) Assignees: WUHAN UNIVERSITY OF SCIENCE AND TECHNOLOGY, Wuhan (CN); WUKE XINCAI (WUHAN) TECHNOLOGY CO., LTD., Wuhan (CN); WUKE COMPOSITE MATERIALS (HAIKOU) TECHNOLOGY CO., LTD., Haikou (CN); SINO-ENERGY HUAYUAN FLOATING WIND INSTITUTE, Qingdao (CN)

(21) Appl. No.: 18/434,830

(22) Filed: Feb. 7, 2024

(30) Foreign Application Priority Data
Aug. 3, 2023 (CN) 202310971900.X

(51) Int. Cl. C21D 9/46; C21C 7/06; C21C 7/10; C21D 1/18; C21D 6/00; C21D 8/02; C22C 33/04; C22C 38/00; C22C 38/02; C22C 38/04; C22C 38/12; C22C 38/14

(52) U.S. Cl. CPC C21D 9/46; C21C 7/06; C21C 7/10; C21D 1/18; C21D 6/005; C21D 6/008; C21D 8/0205; C21D 8/021; C21D 8/0226; C21D 8/0247; C22C 33/04; C22C 38/002; C22C 38/02; C22C 38/04; C22C 38/12; C22C 38/14; C21D 2211/005; C21D 2211/009

(57) ABSTRACT

A high-strength steel with excellent neutral aqueous medium corrosion resistance, and a preparation method and application thereof are provided. A steel plate is designed with cheap chemical compositions of low carbon, low silicon and medium manganese, and is completely free of precious metal elements such as Cr, Ni and Cu, thereby greatly reducing the material cost. According to the present invention, instead of the traditional Al deoxidation technology, Si or Si—Mn deoxidation assisted by Zr—Ti composite deoxidation is used to form a fine, dispersed and uniform composite oxysulfide, which greatly decreases the density of corrosion-active inclusions, and obviously improves the neutral aqueous medium corrosion resistance. Through the design of low carbon equivalent, the steel plate has excellent welding performance; and the composite microalloying of Nb, Zr and Ti is adopted to cooperate with the TMCP rolling parameter control, so that the steel plate has high strength and good extensibility.

### CROSS REFERENCE TO THE RELATED APPLICATIONS

This application is based upon and claims priority to Chinese Patent Application No. 202310971900.X, filed on Aug. 3, 2023, the entire contents of which are incorporated herein by reference.

### TECHNICAL FIELD

The present invention belongs to the technical field of metal materials, and particularly relates to a high-strength steel with excellent neutral aqueous medium corrosion resistance as well as a preparation method and application thereof.

### BACKGROUND

At present, most of corrosion-resistant steels are mainly concentrated in corrosion resistance situations such as seawater corrosion resistance, atmospheric corrosion resistance, crude oil corrosion resistance, and acid and alkali corrosion resistance. The adopted main technical solution is as follows: firstly, elements such as Ni, Cr, Cu and P are utilized to form compact passivation film; secondly, elements such as Cr, Mo and N are utilized to carry out alloying, so that the pitting corrosion resistance is improved; thirdly, a special chemical composition design is utilized to obtain a uniform microstructure, so that the electrode potential difference between different microstructures is eliminated or reduced; fourthly, the refining technology of rare earth, Si—Ca, Fe—Ca and Si—Ca—Ba etc. is utilized to change the morphology and distribution of inclusions; and fifthly, anticorrosive coatings and corrosion inhibitors are adopted to delay corrosion.

Most of human activities are on land, and most of water on land is fresh water, that is, water as a neutral medium. Like seawater, these waters are also very weak electrolytes and also have the corrosive effect. The difference is that these waters do not contain highly corrosive Cl⁻. Inland rivers, lakes, reservoirs and other constructions, sand pumping boat pipelines, mine slurry pump bodies, pipelines, common industrial buildings, civil buildings and other buildings, as well as fences will be eroded by a neutral aqueous medium even when coated with protective paint. The iron and steel materials working in these neutral aqueous medium environments generally are the common low-alloy high-strength steel, or are implemented by using the main technical measures in the above-mentioned five aspects, such as forming compact passivation film from the elements such as Ni, Cr, Cu and P, or are the corrosion-resistant materials such as common stainless steels.

The above technical methods all relate to the problem of high alloy cost, and the problem of local corrosion caused by the neutral aqueous medium cannot be well solved.

### SUMMARY

In order to solve the problems in the prior art, the present invention provides a high-strength steel with excellent neutral aqueous medium corrosion resistance as well as a preparation method and application thereof. The present invention can solve the problems of insufficient neutral aqueous medium corrosion resistance and high alloy cost of the traditional high-strength steel.

The technical solution provided by the present invention is as follows.

A high-strength steel with excellent neutral aqueous medium corrosion resistance includes the following chemical compositions in percentage by mass: 0.021%<C<0.059%, 0.11%<Si<0.29%, 1.35%-1.55% of Mn, 0.02%<Nb+Ti<0.05%, 0.01%<Zr<0.02%, S≤0.0010%, and the balance of Fe and inevitable impurities, and the above chemical compositions also have to satisfy the following formulas: in percentage by mass, \textcircled{1} Nb/Ti=1-3, \textcircled{2} Ti/Zr=2-4, \textcircled{3} Ceq≤0.39, and \textcircled{4} Pcm≤0.17. Ceq is a carbon equivalent and Pcm is a welding crack sensitivity index.

According to the above technical solution, a design of cheap chemical compositions with low carbon, low silicon and medium manganese is adopted, and precious metal elements such as Cr, Ni and Cu are completely not contained, so that the material cost is greatly reduced.

The high-strength steel with excellent neutral aqueous medium corrosion resistance, provided by the above technical solution, can form a fine, dispersed and uniform composite oxysulfide, so that the density of corrosion-active inclusions is greatly decreased, and the neutral aqueous medium corrosion resistance is remarkably improved.

According to the above technical solution, through the design of low carbon equivalent, a steel plate has excellent welding performance.

According to the above technical solution, composite microalloying of Nb, Zr and Ti is adopted to cooperate with thermo-mechanical control process (TMCP) rolling parameter control, so that the steel plate is fine in crystal grain and high in strength and toughness.

The functions of the elements in the high-strength steel with excellent neutral aqueous medium corrosion resistance are as follows.

Carbon: the addition of C may improve the strength. When the content of carbon is increased, the hardenability may be improved. However, as the content of carbon increases, the overall corrosion resistance decreases. In addition, since the increase of the content of carbon promotes the precipitation of carbides and M/A (martensite/austenite), and also affects the local corrosion resistance, the content of carbon should be decreased to improve overall corrosion resistance and local corrosion resistance. Furthermore, the high carbon content is not conducive to improving the welding performance of the steel. Therefore, the content of carbon of the steel according to the present invention is 0.021%<C<0.059%.

Silicon: the Si element may not only play a role of solid solution strengthening but also have a strong deoxidation capability, and is present in an amount of 0.1% or more to play a role of a deoxidizer and to play a role of increasing the strength of the steel. In addition, it is advantageous to increase the content of silicon because silicon is conductive to improving the overall corrosion resistance. However, when the content of silicon is 0.30% or more, the low-temperature toughness and weldability may be deteriorated, and an oxide scale is not prone to being peeled off during rolling to cause surface defects. Therefore, the content of silicon of the steel according to the present invention is 0.11%<Si<0.29%.

Manganese: an Mn element is an important strengthening element in low-alloy high-strength steels. Manganese may effectively increase the strength without decreasing the toughness by solid solution strengthening. However, when the content of manganese is too high, the electrochemical reaction rate of the steel surface may be increased during the corrosion reaction, thereby decreasing the corrosion resistance; and a segregation region may be formed in the center of the thickness to decrease the Z-direction performance and the tear resistance. When the content of manganese is too low, it is difficult to ensure the strength of the steel. Therefore, the content of manganese of the steel according to the present invention is 1.35%<Mn<1.55%.

Titanium: the Ti element is a commonly used microalloying element and has a strong deoxidation capability. When titanium is added in an amount of 0.01% or more, titanium is combined with carbon in the steel to form TiC or Ti (CN), and plays a role in improving the strength due to a precipitation strengthening effect. When Ti is added in an amount of more than 0.05%, the effect of strength improvement is not obvious, and large TiN inclusions may be precipitated, which will damage the plasticity and toughness of the steel. Therefore, the content of titanium of the steel according to the present invention is 0.01%-0.05%.

Niobium: Similar to titanium, Nb is an important microalloying element that is combined with carbon in the steel to form NbC, and plays a role in strengthening the precipitation. When niobium is added in an amount of 0.02% or more, Nb may effectively improve the strength. However, when Nb is added in an amount of 0.05% or more, the effect of strength improvement is not obvious. In addition, if both the content of niobium and the content of carbon are high, the welding performance of the steel will be affected. Therefore, the content of niobium of the steel according to the present invention is 0.01%<Ti<0.05%.

Zirconium: the Zr element is a strong carbide forming element, and also a strong deoxidizing element and a composite oxysulfide forming element. The addition of a small amount of Zr has the effects of degassing, purifying and refining grains, which is conducive to increasing the low-temperature performance of marine engineering steel and improving the stamping performance. When Zr is dissolved into the austenite, the hardenability of the steel is significantly improved. Therefore, the content of zirconium of the marine engineering steel according to the present invention is 0.01%-0.02%.

Sulfur: S is generally present as an impurity in the steel. When the content of sulfur is greater than 0.02%, the ductility, impact toughness, and weldability of the steel are deteriorated. Sulfur is prone to reacting with manganese to form elongated inclusions such as MnS. In addition, voids formed at both ends of the elongated inclusions may be starting points of local corrosion. Sulfur is present as an impurity and is detrimental to local corrosion. Therefore, the upper limit of the content of sulfur is limited to 0.001%, and the lower limit of the content of sulfur is not individually limited.

Specifically, the microstructure type of the high-strength steel is a composite microstructure type of ferrite and pearlite, the area of the ferrite accounts for ≥85%, and the area of the pearlite accounts for ≤15%.

Specifically, the density of the corrosion-active inclusions in the high-strength steel is ≤10/mm².

Specifically, the high-strength steel has a saturation current density of ≤7.0 mA at a static electrode potential E=−300 mV.

The present invention further provides a method for preparing a high-strength steel with excellent neutral aqueous medium corrosion resistance, which includes the following steps:
1) carrying out smelting, refining and vacuum treating on molten steel in sequence, and then continuously casting the molten steel into a casting slab;
2) carrying out conventional heating and soaking on the casting slab;
3) continuously rolling the casting slab into a product steel plate, controlling the final rolling temperature to 750-850° C., and cooling by water to 410-550° C. after rolling; and naturally cooling the steel plate to room temperature to obtain the steel.

Specifically, the smelting in the step 1) specifically includes the following steps: steelmaking molten iron, scrap steel, or molten iron and scrap steel together by using a converter (BOF) or an electric arc furnace (EAF), and then adjusting the temperature and compositions of the molten steel, wherein the tapping temperature is adjusted to 1,560-1,680° C., and the free oxygen content in the molten steel is 121-379 ppm; stirring the molten steel for 4-11 min with fine argon bubbling after the molten steel enters a steel ladle, then carrying out pre-deoxidation by using Fe—Si alloy or Fe—Si—Mn alloy in the steel ladle, so that the free oxygen content in the molten steel is adjusted to 21-95 ppm; stirring with the fine argon bubbling for 4-7 min, and then carrying out final deoxidation by using Fe—Zr—Ti alloy, so as to obtain the molten steel meeting the chemical compositions; the Fe—Zr—Ti alloy is added into the molten steel in the form of blocky alloy or a cored wire, wherein the particle size of the Fe—Zr—Ti alloy is 10-20 mm, and the addition amount of the Fe—Zr—Ti alloy is 0.41-3.5 kg per ton of molten steel.

According to the above technical solution, instead of the traditional Al deoxidation technology, Si or Si—Mn deoxidation assisted by Zr—Ti composite deoxidation is used to form a fine, dispersed and uniform composite oxysulfide, which greatly decreases the density of corrosion-active inclusions, and obviously improves the neutral aqueous medium corrosion resistance. Because the composite microalloying of Nb, Zr and Ti is adopted to cooperate with the TMCP rolling parameter control, so that the effects of fine crystal grains and high strength and toughness of the steel plate are realized.

Specifically, the refining is performed as follows: vacuum degassing (VD) refining or Ruhrstahl-Heraeus (RH) refining is carried out after ladle furnace (LF) refining, and the refined molten steel is continuously cast according to the conventional process.

The present invention further provides application of a high-strength steel with excellent neutral aqueous medium corrosion resistance. The high-strength steel can be used as steel for neutral aqueous medium environments such as steel for marine engineering, ship engineering, bridges, iron towers, rails, crude oil pipelines rich in mineral water for petroleum exploitation, seawater sand pumping, river water sand pumping, cement mixing vehicles or garbage collection vehicles, so that the neutral aqueous medium corrosion resistance of the steel may be obviously improved.

The high-strength steel with excellent neutral aqueous medium corrosion resistance, provided by the present invention, has high neutral aqueous medium corrosion resistance and high strength and toughness, and may be widely used in the above scenes.

### BRIEF DESCRIPTION OF THE DRAWINGS

FIG. 1 is a photomicrograph of corrosion-active inclusions in steel provided in Embodiment 1;

FIG. 2 is a photomicrograph of corrosion-active inclusions in comparative steel Q345;

FIG. 3 is a potentiodynamic polarization result of comparative steel Q345 in a 3.5% NaCl solution;

FIG. 4 is a potentiodynamic polarization result of steel provided in Embodiment 1 in a 3.5% NaCl solution;

FIGS. 5A-5D are alternating current (AC) impedance results of comparative steel Q345 in a 3.5% NaCl solution;

FIGS. 6A-6D are AC impedance results of steel provided in Embodiment 1 in a 3.5% NaCl solution;

FIG. 7 is a potentiostatic polarization result obtained for comparative steel Q345 in a test solution; and

FIG. 8 is a potentiostatic polarization result obtained for steel provided in Embodiment 1 in a test solution.

### DETAILED DESCRIPTION OF THE EMBODIMENTS

The principles and features of the present invention are described below, and the examples given are only for explaining the present invention, not for limiting the scope of the present invention.

### Embodiment 1

An easy-welding and high-strength steel with excellent neutral aqueous medium corrosion resistance includes the following chemical compositions in percentage by mass: 0.039% of C, 0.19% of Si, 1.4% of Mn, 0.035% of Nb, 0.012% of Ti, 0.015% of Zr, 0.008% of S, and the balance of Fe and inevitable impurities.

A smelting and refining method of the easy-welding and high-strength steel is as follows: after performing steelmaking on molten iron by using a converter, the temperature and compositions of the molten steel are adjusted, wherein the tapping temperature is adjusted to 1,620° C., and the free oxygen content in the molten steel is 170 ppm; after entering a steel ladle, the molten steel is stirred for 7 min with fine argon bubbling, and then pre-deoxidized by using Fe—Si alloy in the steel ladle, so that the free oxygen content in the molten steel is adjusted to 63 ppm; stirring is performed for 6 min with fine argon bubbling, and then the final deoxidation is performed with the Fe—Zr—Ti alloy; the Fe—Zr—Ti alloy is added into the molten steel in the form of blocky alloy, and a particle size of the Fe—Zr—Ti alloy is 15 mm; an addition amount of the Fe—Zr—Ti alloy is 1.9 kg per ton of molten steel; and then LF refining and RH refining are performed on the molten steel according to the conventional process.

### Lf Refining:

The viscosity of the refining slag is controlled to 1.511-1.921 Pa·s, so as to improve the inclusion adsorbing capability of a slag system, thereby increasing the cleanliness of the molten steel; the alkalinity R of white slag in a refining furnace is controlled so that 5.31≤R≤7.53, which is conductive to increasing the desulfurization rate, increasing the cleanliness of the molten steel and decreasing oxide inclusions in the molten steel; the MI slag index (=a ratio of CaO/SiO₂:Al₂O₃) is controlled so that MI>0.151, the distribution coefficient of sulfur is greatly increased, thereby controlling the proper fluidity of refining slag at a certain alkalinity; and the retention time of the white slag is 14.15 min, the refining period is 39.41 min, and the soft blowing time is enabled to be 4.51 min, so as to control the outlet [O] content.

### RH Vacuum Treating:

The air pressure in a vacuum chamber is pumped below 66.61 kPa for 13.30 min, and the bottom argon blowing flow rate is 14.91 m³/h, so as to realize circulation of the molten steel for 4 times; the types and the weights of added alloys are strictly controlled, alloys with higher grades, such as low-carbon ferromanganese, metal manganese, low-carbon ferrosilicon and ferrotitanium, are used to ensure that the compositions of the molten steel are completely qualified, and the vacuum is kept for more than 5.17 min after the alloys are added to obtain purer molten steel; and at the same time, a suitable molten steel temperature is provided for continuous casting, which ensures that the superheat of a tundish is 19.66° C. above the liquidus.

Then the refined molten steel is continuously cast according to the conventional process: the temperature of the continuous casting tundish is 1,541° C., and the pulling speed is 1.21 m/s.

A rolling process of the easy-welding and high-strength steel includes the following steps: heating the casting slab at 1,185° C. and keeping for 3.5 hours; continuously rolling the casting slab into a product steel plate, controlling the final rolling temperature to 810° C., and cooling by water to 480° C. after rolling; and naturally cooling to the room temperature for later use.

The microstructure type of the steel plate obtained by the above process is ferrite and pearlite, the area of the ferrite accounts for 87% and the area of the pearlite accounts for 12%. The density of corrosion-active inclusions in the steel plate is 8/mm². The saturation current density of the steel plate at a static electrode potential (E=−300 mV) is 6.5 mA. The steel plate has a yield strength of 380 MPa, a tensile strength of 540 MPa, and an elongation of 35%.

### Embodiment 2

An easy-welding and high-strength steel with excellent neutral aqueous medium corrosion resistance includes the following chemical compositions in percentage by mass: 0.058% of C, 0.28% of Si, 1.53% of Mn, 0.038% of Nb, 0.010% of Ti, 0.018% of Zr, 0.0010% of S, and the balance of Fe and inevitable impurities.

A smelting and refining method of the easy-welding and high-strength steel is as follows: after performing steelmaking on molten iron by using a converter, the temperature and compositions of the molten steel are adjusted, wherein the tapping temperature is adjusted to 1,670° C., and the free oxygen content in the molten steel is 370 ppm; after entering the steel ladle, the molten steel is stirred for 10 min with fine argon bubbling, and then pre-deoxidized by using Fc-Si alloy in the steel ladle, so that the free oxygen content in the molten steel is adjusted to 90 ppm; stirring is performed for 7 min with fine argon bubbling, and then the final deoxidation is performed with Fe—Zr—Ti alloy; the Fe—Zr—Ti alloy is added into the molten steel in the form of blocky alloy, and a particle size of the Fe—Zr—Ti alloy is 18 mm; an addition amount of the Fe—Zr—Ti alloy is 3.1 kg per ton of molten steel; and then LF refining and RH refining are performed on the molten steel according to the conventional process.

### Lf Refining:

The viscosity of the refining slag is controlled to 1.523-1.937 Pa·s, so as to improve the inclusion adsorbing capability of a slag system, thereby increasing the cleanliness of the molten steel; the alkalinity R of white slag in a refining furnace is controlled so that 5.23≤R≤7.47, which is conductive to increasing the desulfurization rate, increasing the cleanliness of the molten steel and decreasing oxide inclusions in the molten steel; the MI slag index (=a ratio of CaO/SiO₂:Al₂O₃) is controlled so that MI>0.153, the distribution coefficient of sulfur is greatly increased, thereby controlling the proper fluidity of refining slag at a certain alkalinity; and the retention time of the white slag is 14.33 min, the refining period is 39.43 min, and the soft blowing time is enabled to be 4.54 min, so as to control the outlet [O] content.

### RH Vacuum Treating

The air pressure in a vacuum chamber is pumped below 66.63 kPa for 13.35 min, and the bottom argon blowing flow rate is 14.93 m³/h, so as to realize circulation of the molten steel for 5 times; the types and the weights of added alloys are strictly controlled, alloys with higher grades, such as low-carbon ferromanganese, metal manganese, low-carbon ferrosilicon and ferrotitanium, are used to ensure that the compositions of the molten steel are completely qualified, and the vacuum is kept for more than 5.33 min after the alloys are added to obtain purer molten steel; and at the same time, a suitable molten steel temperature is provided for continuous casting, which ensures that the superheat of a tundish is 19.7° C. above the liquidus.

Then the refined molten steel is continuously cast according to the conventional process: the temperature of the continuous casting tundish is 1,543° C., and the pulling speed is 1.18 m/s.

A rolling process of the easy-welding and high-strength steel includes the following steps: heating the casting slab at 1,198° C. and keeping for 3.4 hours; continuously rolling the casting slab into a product steel plate, controlling the final rolling temperature to 840° C., and cooling by water to 540° C. after rolling; and naturally cooling to the room temperature for later use.

The microstructure type of the steel plate obtained by the above process is ferrite and pearlite, the area of the ferrite accounts for 88% and the area of the pearlite accounts for 12%. The density of corrosion-active inclusions in the steel plate is 9/mm². The saturation current density of the steel plate at a static electrode potential (E=−300 mV) is 6.8 mA. The steel plate has a yield strength of 390 MPa, a tensile strength of 560 MPa, and an elongation of 34%.

### Embodiment 3

An easy-welding and high-strength steel with excellent neutral aqueous medium corrosion resistance includes the following chemical compositions in percentage by mass: 0.030% of C, 0.15% of Si, 1.48% of Mn, 0.030% of Nb, 0.015% of Ti, 0.012% of Zr, 0.009% of S, and the balance of Fe and inevitable impurities.

A smelting and refining method of the easy-welding and high-strength steel is as follows: after performing steelmaking on molten iron by using a converter, the temperature and compositions of the molten steel are adjusted, wherein the tapping temperature is adjusted to 1,610° C., and the free oxygen content in the molten steel is 149 ppm; after entering the steel ladle, the molten steel is stirred for 5 min with fine argon bubbling, and then pre-deoxidized by using Fe—Si alloy in the steel ladle, so that the free oxygen content in the molten steel is adjusted to 31 ppm; stirring is performed for 5 min with fine argon bubbling, and then the final deoxidation is performed with the Fe—Zr—Ti alloy; the Fe—Zr—Ti alloy is added into the molten steel in the form of blocky alloy, and a particle size of the Fe—Zr—Ti alloy is 12 mm; an addition amount of the Fe—Zr—Ti alloy is 0.81 kg per ton of molten steel; and then LF refining and RH refining are performed on the molten steel according to the conventional process.

### Lf Refining:

The viscosity of the refining slag is controlled to 1.525-1.935 Pa·s, so as to improve the inclusion adsorbing capability of a slag system, thereby increasing the cleanliness of the molten steel; the alkalinity R of white slag in a refining furnace is controlled so that 5.25≤R≤7.45, which is conductive to increasing the desulfurization rate, increasing the cleanliness of the molten steel and decreasing oxide inclusions in the molten steel; the MI slag index (=a ratio of CaO/SiO₂:Al₂O₃) is controlled so that MI>0.152, the distribution coefficient of sulfur is greatly increased, thereby controlling the proper fluidity of refining slag at a certain alkalinity; and the retention time of the white slag is 14.35 min, the refining period is 39.45 min, and the soft blowing time is enabled to be 4.55 min, so as to control the outlet [O] content.

### RH Vacuum Treating

The air pressure in a vacuum chamber is pumped below 66.65 kPa for 13.31 min, and the bottom argon blowing flow rate is 14.95 m³/h, so as to realize circulation of the molten steel for 6 times; the types and the weights of added alloys are strictly controlled, alloys with higher grades, such as low-carbon ferromanganese, metal manganese, low-carbon ferrosilicon and ferrotitanium, are used to ensure that the compositions of the molten steel are completely qualified, and the vacuum is kept for more than 5.35 min after the alloys are added to obtain purer molten steel; and at the same time, a suitable molten steel temperature is provided for continuous casting, which ensures that the superheat of a tundish is 19.7° C. above the liquidus.

Then the refined molten steel is continuously cast according to the conventional process: the temperature of the continuous casting tundish is 1,545° C., and the pulling speed is 1.15 m/s.

A rolling process of the easy-welding and high-strength steel includes the following steps: heating the casting slab at 1,215° C. and keeping for 3.3 hours; continuously rolling the casting slab into a product steel plate, controlling the final rolling temperature to 770° C., and cooling by water to 450° C. after rolling; and naturally cooling to the room temperature for later use.

The microstructure type of the steel plate obtained by the above process is ferrite and pearlite, the area of the ferrite accounts for 85% or more and the area of the pearlite accounts for 15% or more. The density of corrosion-active inclusions in the steel plate is 7/mm². The saturation current density of the steel plate at a static electrode potential (E=−300 mV) is 6.7 mA. The steel plate has a yield strength of 400 MPa, a tensile strength of 580 MPa, and an elongation of 33%.

### Comparative Example 1

An easy-welding and high-strength steel obtained by adopting a conventional Al deoxidation process includes the following chemical compositions in percentage by mass: 0.038% of C, 0.22% of Si, 1.5% of Mn, 0.033% of Nb, 0.015% of Ti, 0.035% of Al, 0.007% of S, and the balance of Fe and inevitable impurities.

A smelting and refining method of the easy-welding and high-strength steel is as follows: after performing steelmaking on molten iron by using a converter, the temperature and compositions of the molten steel are adjusted, wherein the tapping temperature is adjusted to 1,630° C., and the free oxygen content in the molten steel is 180 ppm; after entering the steel ladle, the molten steel is stirred for 7 min with fine argon bubbling, and then the final deoxidation is performed by feeding pure Al wires in the steel ladle, and then LF refining and RH refining are performed on the molten steel according to the conventional process.

### Lf Refining:

The viscosity of the refining slag is controlled to 1.527-1.939 Pa·s, so as to improve the inclusion adsorbing capability of a slag system, thereby increasing the cleanliness of the molten steel; the alkalinity R of white slag in a refining furnace is controlled so that 5.27<R≤7.48, which is conductive to increasing the desulfurization rate, increasing the cleanliness of the molten steel and decreasing oxide inclusions in the molten steel; the MI slag index (=a ratio of CaO/SiO₂:Al₂O₃) is controlled so that MI>0.157, the distribution coefficient of sulfur is greatly increased, thereby controlling the proper fluidity of refining slag at a certain alkalinity; and the retention time of the white slag is 14.37 min, the refining period is 39.49 min, and the soft blowing time is enabled to be 4.57 min, so as to control the outlet [O] content.

### RH Vacuum Treating

The air pressure in a vacuum chamber is pumped below 66.69 kPa for 13.33 min, and the bottom argon blowing flow rate is 14.98 m³/h, so as to realize circulation of the molten steel for 5 times; the types and the weights of added alloys are strictly controlled, alloys with higher grades, such as low-carbon ferromanganese, metal manganese, low-carbon ferrosilicon and ferrotitanium, are used to ensure that the compositions of the molten steel are completely qualified, and the vacuum is kept for more than 5.39 min after the alloys are added to obtain purer molten steel; and at the same time, a suitable molten steel temperature is provided for continuous casting, which ensures that the superheat of a tundish is 19.79° C. above the liquidus.

Then the refined molten steel is continuously cast according to the conventional process: the temperature of the continuous casting tundish is 1,539° C., and the pulling speed is 1.25 m/s.

A rolling process of the easy-welding and high-strength steel includes the following steps: heating the casting slab at 1,218° C. and keeping for 3.4 hours; continuously rolling the casting slab into a product steel plate, controlling the final rolling temperature to 815° C., and cooling by water to 485° C. after rolling; and naturally cooling to the room temperature for later use.

The microstructure type of the steel plate obtained by the above process is ferrite and pearlite, the area of the ferrite accounts for 85% and the area of the pearlite accounts for 15%. The density of corrosion-active inclusions in the steel plate is 18/mm². The saturation current density of the steel plate at a static electrode potential (E=−300 mV) is 8.5 mA. The steel plate has a yield strength of 370 MPa, a tensile strength of 525 MPa, and an elongation of 33%.

The corrosion resistance of the high-strength steel with excellent neutral aqueous medium corrosion resistance prepared in Embodiment 1 is analyzed and tested below, and the result is as follows.

### 1. Test Method

Determination of the density of the corrosion-active inclusions: a sample is cut into a size of 10 mm×10 mm×10 mm, the surface is mechanically ground to 1,500 meshes and then polished to a mirror surface, and a corrosion reagent is prepared according to the following proportion: every 100 mL of ethanol solution contains 5.0 mL of concentrated hydrochloric acid, 0.12 g of CuCl₂, 0.06 g of SnCl₂, and 3.0 g of FeCl₃, the corrosion reagent is dropped on the surface of the sample for treatment for 8 s, then the surface is rinsed with alcohol and blow-dried, and the density of the corrosion-active inclusions is counted by placing the sample under a metallographic microscope at a magnification of 100×.

The environment of an electrochemical corrosion experiment is at a room temperature, and the corrosive solution is a 3.5% of NaCl solution, which simulates a corrosion environment. The electrode is implemented by a classic tri-electrode system: the sample is a working electrode, a platinum electrode is an auxiliary electrode, and a saturated calomel electrode (SCE) is a reference electrode. An electrochemical device is a ZAHNER electrochemical workstation. Parameters are set by the Thales electrochemical software, and the workstation is connected to a computer for data display.

The electrochemical corrosion experiment is carried out at the room temperature, and a potentiodynamic polarization curve (Tafel) and an electrochemical impedance (EIS) of a small sheet sample are tested. Before the test, the sample is soaked in the corrosive solution for 40 min, and then electrochemical impedance and potentiodynamic polarization tests are carried out after an open circuit potential (OCP) is stable. The transition signal of sine waves applied by the electrochemical impedance is 10 mV, and a test scanning range is 10 mHz to 10 kHz. A scanning rate of the potentiodynamic polarization curve is 0.5 mV/s and a scanning range is-600 mV to 1.2V. The potentiodynamic polarization curve and an electrochemical impedance curve are fitted by the Origin and Zsimpwin softwares respectively.

An AC impedance method disturbs the electrode system with small-amplitude sine waves of different frequencies, an equivalent circuit of the electrodes is inferred through the relationship between a response of the electrode system and a disturbance signal, and the parameters of various elements in the equivalent circuit are fitted, so as to obtain corrosion kinetic parameters of the material, and directly and quantitatively analyze factors affecting the corrosion resistance of the material and further understand corrosion behaviors of the material.

The corrosion electrochemical experiment is carried out in the classical tri-electrode system, the electrochemical sample to be tested serves as the working electrode, the saturated calomel electrode (SCE) serves as the reference electrode, a platinum sheet serves as a counter electrode, and the test temperature is normal temperature 25° C. At the room temperature, for a weld metal in an as-welded state, the OCP is tested by soaking the sample in the corrosive solution, the test time is 40 min, and then the electrochemical impedance test is started after the OCP is stable. The amplitude of the sine waves applied by the electrochemical AC impedance is 10 mV, the scanning frequency range is 10 mHz to 10 kHz, and the scanning time is 40 min.

### 2. Test Results and Analysis

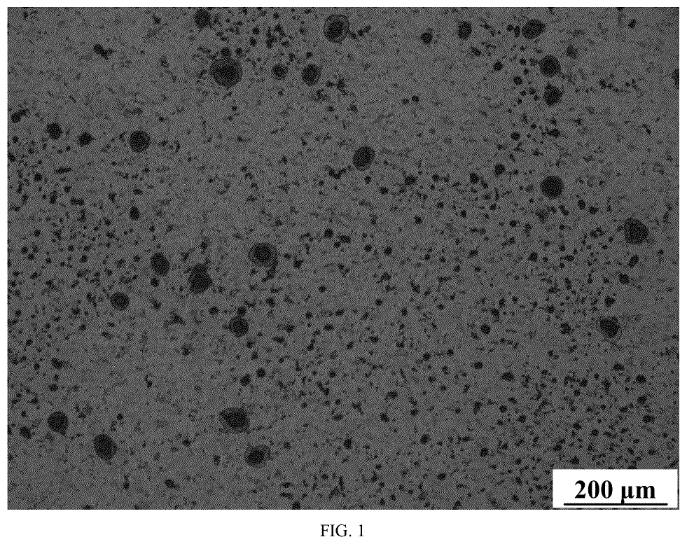

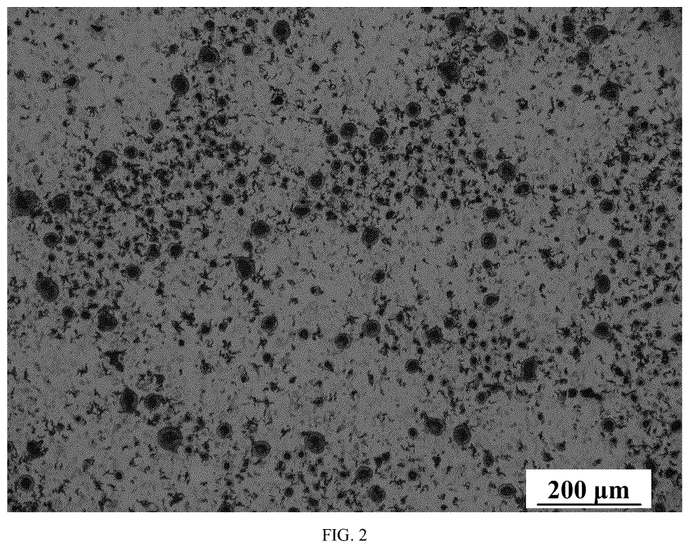

FIG. 1 is a photomicrograph of corrosion-active inclusions in steel provided in Embodiment 1, and the measurement result shows that the density of corrosion-active inclusions in the steel provided by Embodiment 1 is 5/mm². FIG. 2 is a photomicrograph of corrosion-active inclusions in comparative steel Q345, and the measurement result shows that the density of corrosion-active inclusions in the comparative steel Q345 is 18/mm². The density of the corrosion-active inclusions in the steel provided in Embodiment 1 is much lower than that of the corrosion-active inclusions of the comparative steel Q345.

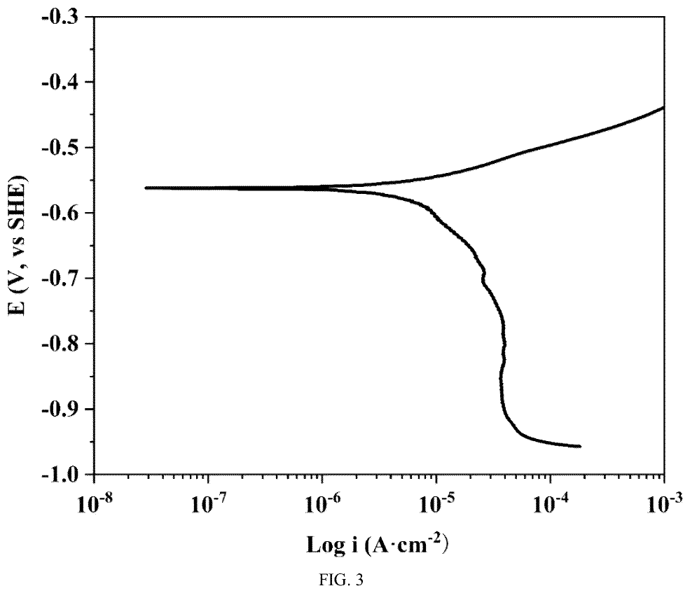

FIG. 3 is a potentiodynamic polarization result of comparative steel Q345 in a 3.5% NaCl solution. As can be seen from FIG. 3, the comparative steel has a corrosion potential of −0.5619V and a corrosion current density of 8.5×10⁻⁵ A·cm⁻².

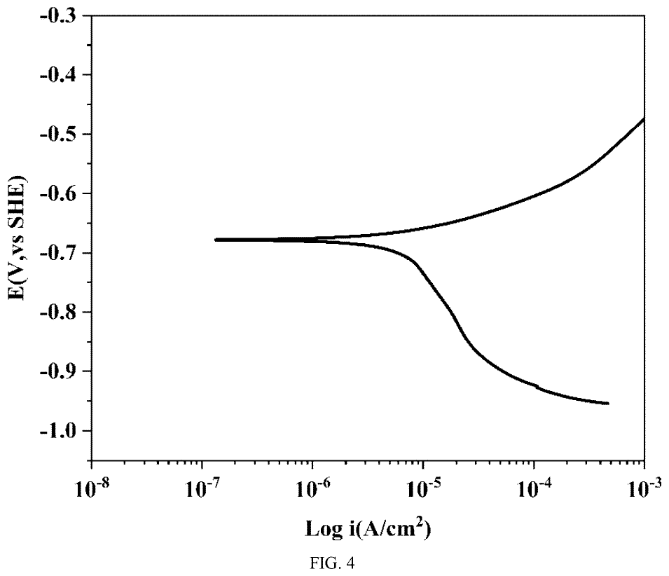

FIG. 4 is a potentiodynamic polarization result of steel provided in Embodiment 1 in a 3.5% NaCl solution. As can be seen from FIG. 4, the steel provided in Embodiment 1 has a corrosion potential of −0.678V and a corrosion current density of 1.508×10⁻⁵ A·cm⁻².

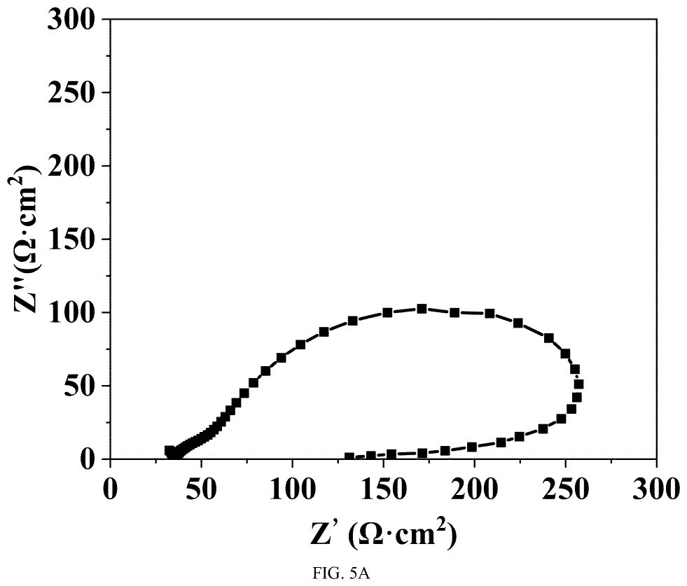

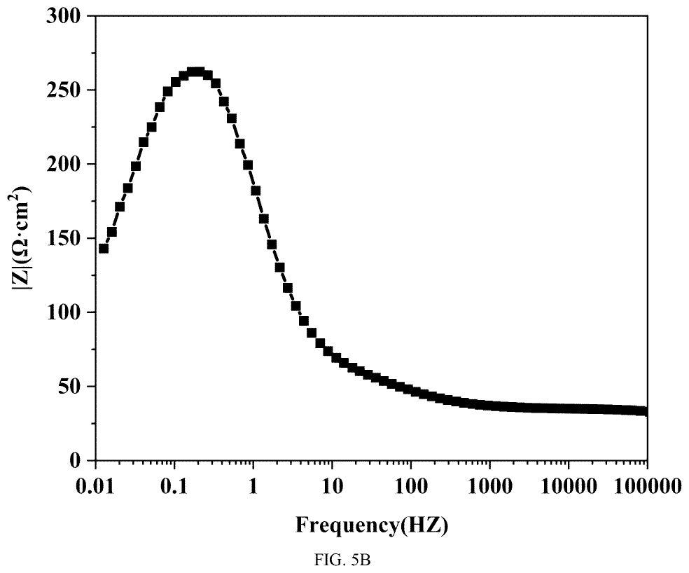

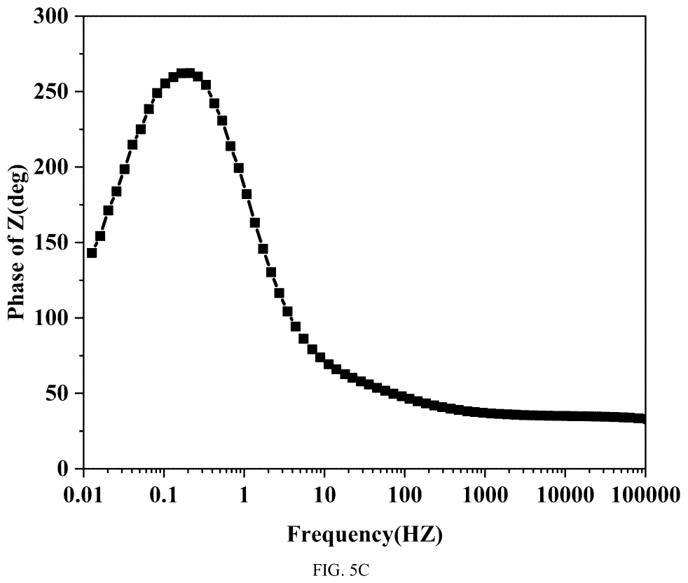

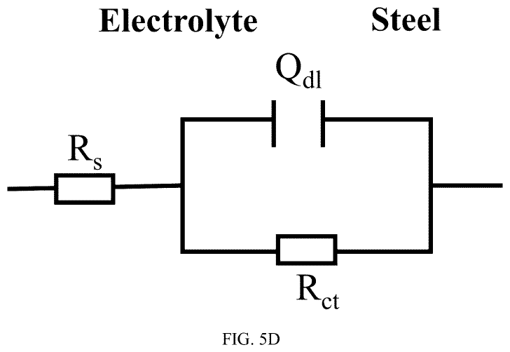

FIGS. 5A-5D and Table 1 are AC impedance results of comparative steel Q345 in a 3.5% NaCl solution. The constant phase angle index n in Table 1 reflects the deviation between an actual capacitance and an ideal capacitance. The larger the value of n, the smaller the deviation between the actual capacitance and the ideal capacitance. Generally, the value of n of the electric double layer capacitance of a corroding electrode is between 0.5 and 1. As can be seen from FIG. 3 and Table 1, the comparative steel shows a charge transfer resistance of 233.7 Ω·cm⁻².

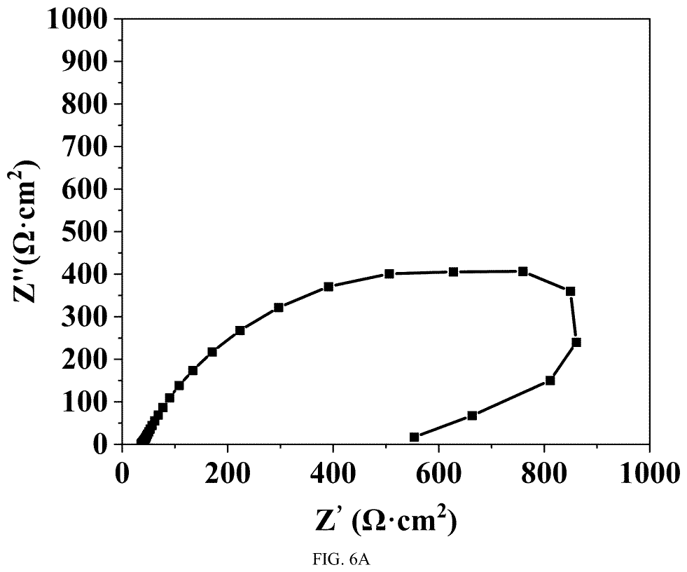

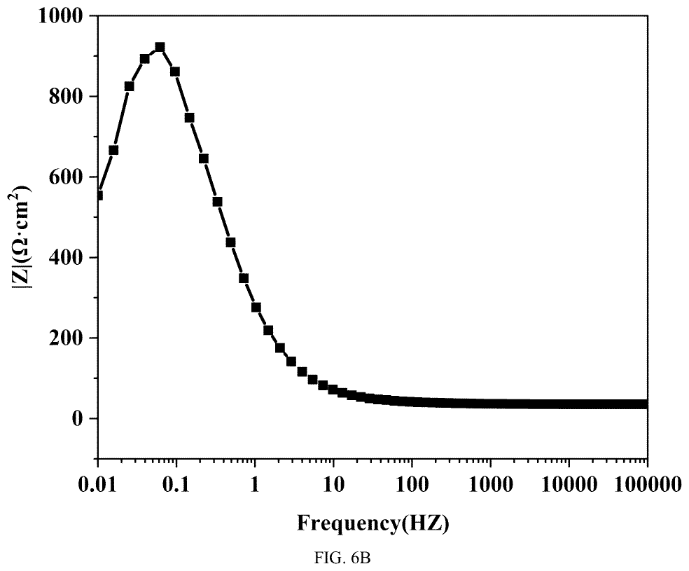

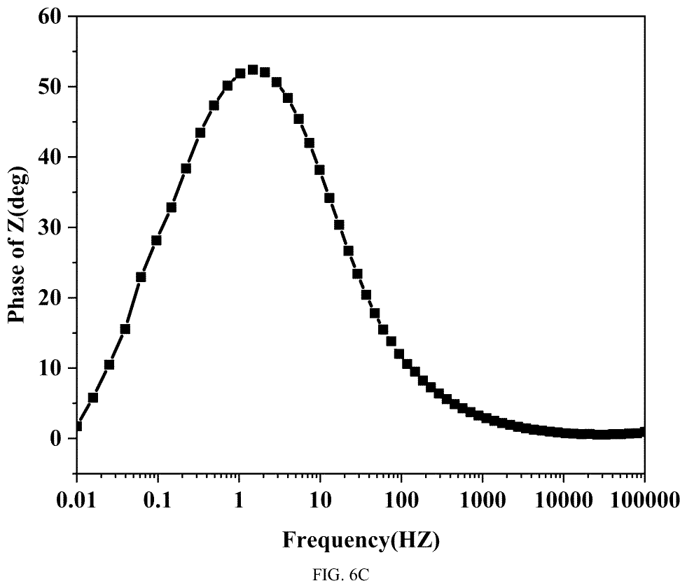

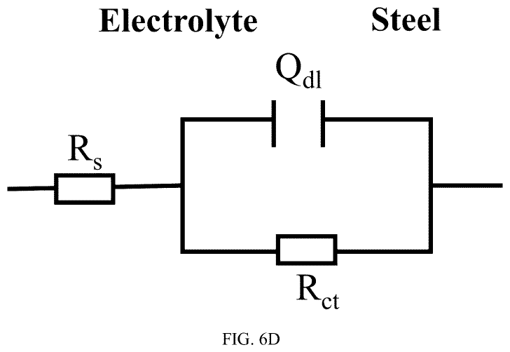

FIGS. 6A-6D and Table 2 are an AC impedance test result of steel provided in Embodiment 1 in a 3.5% NaCl solution. As can be seen from FIG. 4 and Table 2, the comparative steel shows a charge transfer resistance of 956.3 Ω·cm⁻².

TABLE 1
AC impedance fitting result of comparative steel
Q345 in 3.5% NaCl solution

| | | | Constant | |
|---|---|---|---|---|
| | | | phase | |
| | Rₛ, | Y₀, | angle | R_{ct}, |
| | (Ω · cm⁻²) | (S · secⁿ · cm⁻²) | index n | (Ω · cm⁻²) |
| comparative | 36.24 | 0.001118 | 0.683 | 233.7 |
| steel Q345 | | | | |

TABLE 2
AC impedance fitting result of steel provided in
Embodiment 1 in 3.5% NaCl solution

| | | | Constant | |
|---|---|---|---|---|
| | | | phase | |
| | Rₛ, | Y₀, | angle | R_{ct}, |
| | (Ω · cm⁻²) | (S · secⁿ · cm⁻²) | index n | (Ω · cm⁻²) |
| steel of the | 36.53 | 0.0008117 | 0.7775 | 956.3 |
| present | | | | |
| invention | | | | |

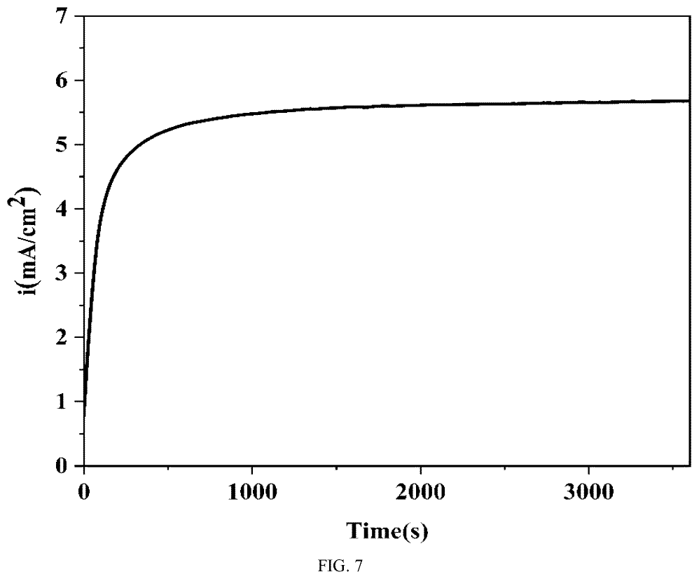

FIG. 7 is a saturation current density of 8.5 mA/cm² obtained in the potentiostatic polarization test of the comparative steel Q345 test sample. It is generally considered that: 6 mA/cm²≤saturation current density≤8 mA/cm² indicates good neutral aqueous medium corrosion resistance.

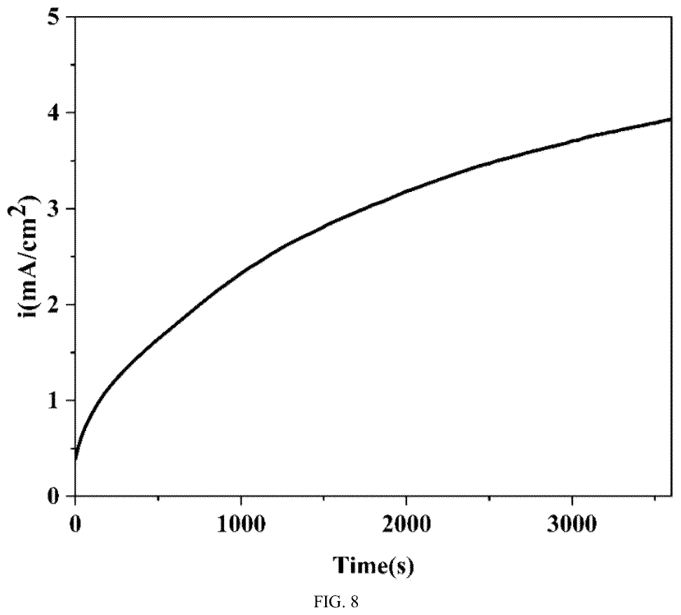

FIG. 8 is a saturation current density of 3.93 mA/cm² obtained in the potentiostatic polarization test of the steel provided in Embodiment 1. It is generally considered that: saturation current density≤6 mA/cm² indicates excellent neutral aqueous medium corrosion resistance.

According to the above results, the order of the corrosion current density is: the comparative steel Q345>the steel provided in Embodiment 1, the order of the charge transfer resistance is: the comparative steel Q345<the steel provided in Embodiment 1, and the order of the saturation current density is: the comparative steel Q345>the steel provided in Embodiment 1, which indicate that the neutral aqueous medium corrosion resistance of the steel provided in Embodiment 1 is excellent and is obviously superior to that of the comparative steel Q345.

In summary, the steel plate according to the present invention is designed with cheap chemical compositions of low carbon, low silicon and medium manganese, and is completely free of precious metal elements such as Cr, Ni and Cu, thereby greatly reducing the material cost. According to the present invention, instead of the traditional Al deoxidation technology, Si or Si—Mn deoxidation assisted by Zr—Ti composite deoxidation is used to form a fine, dispersed and uniform composite oxysulfide, which greatly decreases the density of the corrosion-active inclusions and significantly improves the neutral aqueous medium corrosion resistance. According to the present invention, through the design of low carbon equivalent, the steel plate has excellent welding performance; and the composite microalloying of Nb, Zr and Ti is adopted to cooperate with the TMCP rolling parameter control, so that the steel plate has high strength and good extensibility. The steel is especially suitable for steel used in neutral aqueous medium environments such as steel for marine engineering, ship engineering, bridges, iron towers, rails, crude oil pipelines rich in mineral water for petroleum exploitation, seawater sand pumping, river water sand pumping, cement mixing vehicles or garbage collection vehicles, so that the neutral aqueous medium corrosion resistance of the steel can be obviously improved.

The above description involves only preferred embodiments of the present invention, and is not intended to limit the present invention. Any modification, equivalent substitution, improvement, etc. within the spirit and principle of the present invention shall be included in the protection scope of the present invention.

What is claimed is:

1. A high-strength steel with an excellent neutral aqueous medium corrosion resistance, comprising chemical compositions in a percentage by mass as follows: 0.021%<C<0.059%, 0.11%<Si<0.29%, 1.35%<Mn<1.55%, 0.02%<Nb+Ti<0.05%, 0.01%<Zr<0.02%, S≤ 0.0010%, and a balance of Fe and inevitable impurities, wherein the chemical compositions satisfy the following formulas: in the percentage by mass, Nb/Ti=1-3, Ti/Zr=2-4, a carbon equivalent (Ceq)≤0.39, and a welding crack sensitivity index (Pcm)≤0.17.

2. The high-strength steel with the excellent neutral aqueous medium corrosion resistance according to claim 1, wherein a microstructure type of the high-strength steel is a composite microstructure type of ferrite and pearlite, an area of the ferrite accounts for ≥85%, and an area of the pearlite accounts for ≤15%.

3. The high-strength steel with the excellent neutral aqueous medium corrosion resistance according to claim 1, wherein a density of corrosion-active inclusions in the high-strength steel is ≤10/mm².

4. The high-strength steel with the excellent neutral aqueous medium corrosion resistance according to claim 1, wherein the high-strength steel has a saturation current density of ≤7.0 mA at a static electrode potential E=−300 mV.

5. A method for preparing the high-strength steel with the excellent neutral aqueous medium corrosion resistance according to claim 1, comprising following steps:
1) carrying out smelting, refining and vacuum treating on a molten steel in sequence to obtain a treated molten steel, and then continuously casting the treated molten steel into a casting slab;
2) carrying out heating and soaking on the casting slab to obtain a resulting casting slab;
3) continuously rolling the resulting casting slab into a product steel plate, controlling a final rolling temperature to 759-859° C., and cooling the product steel plate by water to 411-549° C. after rolling to obtain a water-cooled steel plate; and
4) naturally cooling the water-cooled steel plate to room temperature to obtain the high-strength steel.

6. The method according to claim 5, wherein the smelting in step 1) comprises following steps: steelmaking a molten iron, a scrap steel, or the molten iron and the scrap steel together by using a converter or an electric arc furnace to obtain the molten steel, and then adjusting a temperature and compositions of the molten steel, wherein a tapping temperature is adjusted to 1,560-1,680° C., and a free oxygen content in the molten steel is 121-379 ppm; stirring the molten steel for 4-11 min with a fine argon bubbling after the molten steel enters a steel ladle, then carrying out a pre-deoxidation by using a Fe—Si alloy or a Fe—Si—Mn alloy in the steel ladle, so that the free oxygen content in the molten steel is adjusted to 21-95 ppm; stirring with the fine argon bubbling for 4-7 min, and then carrying out a final deoxidation by using a Fe—Zr—Ti alloy to obtain the molten steel meeting the chemical compositions; the Fe—Zr—Ti alloy is added into the molten steel in a form of a blocky alloy or a cored wire, wherein a particle size of the Fe—Zr—Ti alloy is 10-20 mm, and an addition amount of the Fe—Zr—Ti alloy is 0.41-3.5 kg per ton of the molten steel.

7. The method according to claim 5, wherein the refining is performed as follows: a vacuum degassing (VD) refining or a Ruhrstahl-Heraeus (RH) refining is carried out after a ladle furnace (LF) refining, and a refined molten steel is continuously cast according to a conventional process.

8. A method of using the high-strength steel with the excellent neutral aqueous medium corrosion resistance according to claim 1, comprising using the high-strength steel as a steel for a marine engineering, a ship engineering, bridges, iron towers, rails, crude oil pipelines rich in mineral water for a petroleum exploitation, a seawater sand pumping, a river water sand pumping, cement mixing vehicles, or garbage collection vehicles.

9. The high-strength steel with the excellent neutral aqueous medium corrosion resistance according to claim 2, wherein the high-strength steel has a saturation current density of ≤7.0 mA at a static electrode potential E=−300 mV.

10. The high-strength steel with the excellent neutral aqueous medium corrosion resistance according to claim 3, wherein the high-strength steel has a saturation current density of ≤7.0 mA at a static electrode potential E=−300 mV.

11. The method according to claim 5, wherein a microstructure type of the high-strength steel is a composite microstructure type of ferrite and pearlite, an area of the ferrite accounts for ≥85%, and an area of the pearlite accounts for ≤15%.

12. The method according to claim 5, wherein a density of corrosion-active inclusions in the high-strength steel is ≤10/mm².

13. The method according to claim 5, wherein the high-strength steel has a saturation current density of ≤7.0 mA at a static electrode potential E=−300 mV.

14. The method according to claim 6, wherein the refining is performed as follows: a VD refining or an RH refining is carried out after an LF refining, and a refined molten steel is continuously cast according to a conventional process.

15. The method according to claim 8, wherein a microstructure type of the high-strength steel is a composite microstructure type of ferrite and pearlite, an area of the ferrite accounts for ≥85%, and an area of the pearlite accounts for ≤15%.

16. The method according to claim 8, wherein a density of corrosion-active inclusions in the high-strength steel is ≤10/mm².

17. The method according to claim 8, wherein the high-strength steel has a saturation current density of ≤7.0 mA at a static electrode potential E=−300 mV.
